(19) United States
(12) Patent Application Publication
(10) Pub. No.: US 2025/0207602 A1
(43) Pub. Date: Jun. 26, 2025

(54) FLOW-GENERATION SYSTEM AND METHOD FOR ITS OPERATION

(71) Applicant: ebm-papst Mulfingen GmbH & Co. KG, Mulfingen (DE)

(72) Inventors: Sebastian Schroth, Kupferzell (DE); Sébastien Heini, Urmatt (FR)

(21) Appl. No.: 18/989,642

(22) Filed: Dec. 20, 2024

(30) Foreign Application Priority Data
Dec. 22, 2023 (DE) 10 2023 136 494.4

(51) Int. Cl. F04D 27/00; F04D 25/08

(52) U.S. Cl. CPC F04D 27/007; F04D 25/08

(57) ABSTRACT

The present disclosure relates to a flow-generation system and to a method for its operation. The flow-generation system has a plurality of flow-generation units, which are each configured to generate an individual fluid flow, in particular an air flow. For this purpose, the flow-generation unit can comprise an electromotively operated fan, for example. A local controller has a processor, a working memory, and a process scheduler, and is connected to a communication network for communication via a communication interface. A control task can be processed in parallel by a network group by means of a plurality of local controllers of the flow-generation units belonging to the network group when one single local controller does not have enough computing power and/or memory capacity for processing the control task. In this case, complex control tasks can also be processed without an internet-based service (cloud service) connected to the flow-generation system or a server or increased computing and memory capacity of the local controllers necessarily being required for this purpose.

This application claims priority under 35 U.S.C. § 119 to the following German Patent Application No. 10 2023 136 494.4, filed on Dec. 22, 2023, the entire contents of which are incorporated herein by reference thereto.

### TECHNICAL FIELD

The present disclosure relates to a flow-generation system comprising a plurality of flow-generation units, which are connected for communication by means of a communication network. The present disclosure also relates to a method for operating a flow-generation system of this kind.

### BACKGROUND

Each flow-generation unit is configured to generate a fluid flow. A fluid flow can be a liquid flow or a gas flow.

The flow-generation system can be part of a ventilation system, a heating system, a cooling system, or an air-conditioning system, for example.

Standard flow-generation units only have limited computing power. More complex control tasks are therefore not often managed by the flow-generation unit or its processor. As the complexity of the control tasks increases, so does the need for computing power in the flow-generation units. This results in high costs. Another approach is to provide a central server or an internet-based service or cloud service that takes on the complex control tasks. However, this requires the flow-generation units to network with the central server or the internet-based service. The use of an internet-based service may be undesired for reasons of data security and requires high availability of the internet-based service, which, depending on the installation site of the flow-generation system, cannot always be ensured, for example on sites with an internet connection that is not stable enough. Although a central server at the installation site of the flow-generation system can ensure data security and does not require high availability of an internet connection, either, it results in additional costs.

There is therefore a need for a flow-generation system that can be provided and operated in a cost-effective manner.

U.S. Pat. No. 11,378,938 B2 discloses a system and a method for improving the data usage of a plurality of sensors which are connected to a pump or a fan. The sensor data are subjected to pattern recognition in order to interpret captured sensor data. In this case, machine-learning methods can be used.

Networking radio participants to form a so-called “mesh network” is described in US 2017/0006521 A1.

### BRIEF SUMMARY

The problem addressed by the present disclosure is to provide a flow-generation system that can be provided and operated in a simple and cost-effective manner and in particular makes it possible to process complex control tasks using simple means.

Disclosed is a flow-generation system including a plurality of flow-generation units, which are connected for communication by means of a communication network, wherein each flow-generation unit of the plurality of flow-generation units comprises a local controller having a processor and having a process scheduler and a communication interface connected to the local controller for communication and for connection to the communication network, wherein each flow-generation unit of the plurality of flow-generation units is configured to form a network group together with one or more or all of the other flow-generation units of the plurality of flow-generation units, the network group is configured to process a control task in a distributed manner by the processor of each flow-generation unit of the plurality of flow-generation units of the network group, wherein the process scheduler of one of the plurality of flow-generation units operates as a superordinate scheduler and is configured to define sub-tasks of the control task, to assign the sub-tasks to the processor of each flow-generation unit of the plurality of flow-generation units of the network group, and to combine results of the sub-tasks for processing the control task, wherein the flow-generation system also comprises at least one sensor which provides sensor data for one or more flow-generation units of the plurality of flow-generation units, and wherein the superordinate scheduler is configured to divide the sensor data from the at least one sensor or from at least one of available sensors into data blocks and to allocate each data block of the data blocks to a sub-task.

Also disclosed is a method for operating a flow-generation system including a plurality of flow-generation units, which are connected for communication by means of a communication network, and also comprising at least one sensor which provides sensor data for one or more flow-generation units of the plurality of flow-generation units, wherein each flow-generation unit of the plurality of flow-generation units comprises a local controller having a processor and having a process scheduler and a communication interface connected to the local controller for communication for connection to the communication network, wherein the method includes: specifying a control task, temporarily forming a network group from a plurality of or all of the plurality of flow-generation units for distributed processing of the control task by means of the processor of the plurality of or all of the plurality of flow-generation units of the network group, determining a superordinate scheduler of the process scheduler of each of the plurality of flow-generation units of the network group, defining sub-tasks for processing the control task by means of the superordinate scheduler, dividing the sensor data from the at least one sensor or from at least one of available sensors into data blocks and allocating each data block of the data blocks to a sub-task by means of the superordinate scheduler, allocating each sub-task of the sub-tasks to one processor of the plurality of flow-generation units of the network group, processing each sub-task of the sub-tasks and providing a result of each sub-task of the sub-tasks for the superordinate scheduler by means of the one processor of the plurality of flow-generation units, combining the result of each sub-task of the sub-tasks by means of the superordinate scheduler.

The flow-generation system according to the present disclosure has a plurality of flow-generation units, which are connected for communication by means of a communication network. The communication connection is in particular bidirectional. Each flow-generation unit has a communication interface, which is configured for connection to the communication network.

In addition, each flow-generation unit comprises a local controller having a processor and a process scheduler. The process scheduler of the flow-generation unit can be implemented in the controller by an arithmetic logic device executed separately by the processor by means of a program that can be executed by the processor.

Each flow-generation unit is configured to generate an individual fluid flow. The fluid flows of a plurality of or all of the flow-generation units of the flow-generation system can each be divided into sub-flows and/or can be combined with one another to form an overall fluid flow. A fluid flow can be a liquid flow or a gas flow.

Preferably, one flow-generation unit or a plurality of the available flow-generation units or all of the flow-generation units can comprise a fan, which is configured to generate an air flow. Additionally or alternatively, one flow-generation unit or a plurality of the available flow-generation units or all of the flow-generation units can also comprise a pump for generating a liquid flow.

It is preferable for each flow-generation unit to comprise a controllable electric motor, which, when operated, can drive the rotor of a fan or a pump and can thus generate the fluid flow in question.

At least two of the flow-generation units of the flow-generation system can at least temporarily form a network group when this is required for processing a control task which cannot be processed by the processor of a single flow-generation unit. A control task of this kind that prompts the formation of a network group in particular requires computing capacity that cannot be provided by a single processor of a flow-generation unit. This is particularly applicable when the control task is time-critical and it is therefore supposed to be or needs to be processed within a predetermined time window.

Within the network group, the following is carried out to process the control task:

The controllers of the flow-generation units of the network group select one of the process schedulers of the controllers as the superordinate scheduler. The superordinate scheduler can also be referred to as the master scheduler. The superordinate scheduler is configured to sub-divide the control task, to define single sub-tasks, and to allocate them to the processors of the flow-generation units of the network group.

It is advantageous here for all the sub-tasks to be able to be processed independently of the result of another sub-task, such that all the sub-tasks can be processed in parallel (substantially simultaneously or at least with a time overlap during a processing time interval). The processing durations of the sub-tasks can be of different lengths.

To process the control task, an individual processor only processes the sub-task allocated to it and provides the result of the sub-task to the superordinate scheduler and/or at least one of the other process schedulers again (indirectly via one of the other process schedulers or directly). For this purpose, the processor can transmit the result of the sub-task to the superordinate scheduler and/or at least one of the other process schedulers or request it for retrieval. The superordinate scheduler is also configured to combine the results of the sub-tasks in order to thus obtain a result for the entire control task, which can then be transmitted, output, and/or used within the flow-generation system.

The number of flow-generation units belonging to the network group or their controllers can be determined by the superordinate scheduler depending on the required computing and memory requirement and can thus vary depending on the control task to be processed. After processing the control task, the network group temporarily formed for this purpose can be removed or dissolved again, so to speak. For each control task, a network group grouped as desired from the available flow-generation units or their controllers can be formed, which only exists until all the sub-tasks and thus the control task have been processed.

For example, it may be advantageous to divide data of the control task to be processed into single data blocks or data packets and to allocate each data packet to one of the sub-tasks. Additionally or alternatively, an overall process of the control task can be divided into single smaller computing processes, and these can each be allocated to one of the sub-tasks.

Therefore, complex control tasks, in particular also time-critical control tasks, can be processed by a network group. The computing power of each individual processor and/or a working memory of each controller does not have to be configured to be able to process the control task. The use of a central server or internet-based service or cloud service can be omitted. Optionally, data can be exchanged with an internet-based service or cloud service, for example for preparing the processing of the control task and/or following the processing of the control task and/or independently of the control task. In any case, an internet-based service or cloud service of this kind is not necessarily required and is in particular not required for processing the control task by means of the network group. A stable and fast internet connection to an internet-based service or cloud service is not required. The flow-generation system can for example form a closed network. It can therefore be implemented in a cost-effective manner using simple means without complex hardware components.

Each individual flow-generation unit is preferably configured to control or regulate its individual fluid flow, at least in phases, by means of the respective local controller independently of the other flow-generation units. Each controller can thus perform individual control or regulation without needing to permanently cooperate with another controller. For example, during operation of the flow-generation system, each of the flow-generation units operates autonomously for at least 80% or 90% of the operating time, while it is necessary to form a network group only in at most 20% or at most 10% of the cases for processing complex control tasks.

In this case, the motor controller or a motor control system of an electric motor of the flow-generation unit is in particular used as the controller of the flow-generation unit without the motor controller having to be enhanced by additional computing and/or memory capacity.

It is preferable for the flow-generation system to comprise at least one sensor. The at least one sensor provides sensor data for one or more or all of the flow-generation units. The sensor or at least one of the available sensors can be an individual sensor of one of the flow-generation units. The at least one individual sensor provides the sensor data for the controller of a flow-generation unit. The sensor data from the at least one individual sensor can optionally be provided by the controller in question via the communication network of one or more further controllers.

Additionally or alternatively, the sensor or at least one of the available sensors can be a system sensor. The system sensor can be connected to the communication network for communication independently of a local controller of one of the flow-generation units.

Any sensor or a plurality of sensors can be used in any combination as a sensor, for example: a temperature sensor, a pressure sensor, a flow velocity sensor for capturing a flow velocity of a fluid flow, a flow rate sensor for capturing a flow rate (volume flow rate and/or mass flow rate) of a fluid flow, a humidity sensor for capturing a humidity value, in particular a humidity in the surrounding atmosphere (e.g. air humidity), a sensor for capturing a gas component (e.g. CO2, radon, etc.) in the surrounding atmosphere, in particular an air atmosphere, an oscillation sensor for capturing an oscillation and/or vibration, for example of a body or in a surrounding atmosphere. The oscillation sensor can for example be an acceleration sensor or a microphone.

The evaluation or processing of the sensor data provided by the sensor or by at least one of the available sensors can be a control task, for example. By means of the superordinate scheduler, the sensor data can be divided into data blocks and each data block can be allocated to a sub-task. For example, a sub-task can consist in compressing the data allocated to the sub-task and/or transforming it into a frequency range and/or processing it in some other way. Evaluating and/or processing the sensor data or data blocks in the frequency range can be part of the sub-task. Optionally, it can be part of a sub-task to transform the results of an evaluation and/or processing obtained in the frequency range from the frequency range back into the time range. For example, in this way, sensor data from an oscillation sensor can be transformed into the frequency range by a Fourier transform (in particular FFT) and can then optionally be analyzed on the basis of predetermined criteria.

Additionally or alternatively, the sensor data from a plurality of sensors can be related to one another, correlated with one another, combined with one another, or compared with one another in order to obtain additional information that cannot be obtained from the sensor data from the individual sensors. For example, oscillation data from a plurality of oscillation sensors can be monitored. On the basis of the sensor positions in the system, it can for example be recognized whether the oscillations are caused by the operation of the system or whether oscillations are being introduced from outside the flow-generation system. As explained, the computationally intensive monitoring can be sub-divided into sub-tasks and can be processed by the controllers of the network group.

The fluid flows of a plurality of or all of the flow-generation units of the flow-generation system can each be divided into sub-flows and/or can be combined with one another to form an overall fluid flow in a flow space. For example, the flow-generation units which are fluidically connected to a joint flow space can at least temporarily form a network group. For example, the flow space can be the space in a building that is supposed to be ventilated, heated, cooled, or air-conditioned. For example, the individual flow-generation units can coordinate their individual operation by forming a network group, in order to achieve a superordinate control or regulation objective. A control or regulation objective of this kind can in particular be defined by at least one control parameter of the control task. The at least one control parameter for the flow space can for example be a target temperature, a target humidity of the atmosphere, a target flow velocity, a limit value for a gas component of the atmosphere (e.g. maximum carbon dioxide or radon fraction), a target pressure, etc., or any combination thereof.

In one embodiment, the flow-generation system can comprise an operating interface and/or a gateway. By means of the operating interface and/or gateway, the control task can be specified and/or selected and/or changed, for example. Additionally or alternatively, a result of the processing of the control task can be output or transmitted to a receiver outside the flow-generation system.

In addition to the at least one flow-generation unit, the flow-generation system can also comprise other devices which can be connected to the communication network, such as apparatuses for influencing the flow direction and/or the flow quantity (volume flow rate and/or mass flow rate) of a fluid flow, such as valves, adjustable flow-guiding apparatuses (e.g. flow valves), etc.

In any embodiment, the fluid flow can be generated between two flow spaces, for example between two spaces in a building, or between a flow space and surroundings (e.g. surroundings of a building). It is for example possible here to cause air to be exchanged between a cellar space and a space (habitable space) that is intended and configured for persons to be accommodated in. To provide cooling, air can be conveyed from the cellar into the habitable space, for example. In reverse, to combat humidity in the cellar space, warm air can be conveyed out of the habitable space into the cellar space.

By means of any embodiment of the flow-generation system, one or more of the following methods explained below by way of example can be carried out, for example.

### Example 1

A plurality of flow-generation units, in particular fans, are fluidically connected to a joint flow space (e.g. space in a building) and cause an overall fluid flow therein, which results from the individual fluid flows of the flow-generation units. By forming a temporary network group of these flow-generation units, the individual controllers can be coordinated, for example so as to be time-controlled at regular intervals or in a result-controlled manner. As a result, at least one superordinate control parameter can be adjusted as part of a control task such that one or more variable adjustment options of the flow-generation units can be used in order to fulfill one or more additional boundary conditions. A boundary condition can e.g. be:
controlling and/or regulating a plurality of control parameters independently of one another, for example regulating the temperature and humidity in the flow space;
controlling and/or regulating the control parameter by minimizing the wear, power, or energy consumption of the flow-generation units;
controlling and/or regulating the control parameter by maintaining a boundary condition, for example limiting the resulting overall fluid flow to a maximum flow velocity of the overall fluid flow in the flow space;
controlling and/or regulating the control parameter by selecting one or more or all of the flow-generation units of the network group in order to obtain a desired flow profile of the overall fluid flow in the flow space, for example a position-dependent or site-dependent flow of the overall fluid flow within the flow space, i.e. a three-dimensional flow vector map, so to speak, which describes the direction and/or velocity of the overall fluid flow; for this purpose, the suitably spatially arranged flow-generation units that are fluidically connected to the flow space on the suction side or pressure side can be selected.

### Example 2

The control task consists in ascertaining a remaining service life of one of the flow-generation units, which cannot be carried out, or at least cannot be carried out rapidly enough, by the controller of the flow-generation unit in question owing to the computing power and/or memory capacity required. This control task can, however, be managed by the network group using a plurality of controllers (i.e. in particular processors and a plurality of working memories). The ascertained remaining service life can be used to influence the operation of the flow-generation unit in question and/or can be transmitted via a gateway and/or can be output by means of an operating interface.

### Example 3

The sensor data from a plurality of sensors are related to one another in order to obtain additional information which would overwhelm a single controller. For example, the oscillation data from a plurality of oscillation sensors arranged so as to be distributed in the building can be evaluated in order to establish whether an oscillation or vibration has been generated by the malfunction-free operation of the flow-generation system or by a malfunction of one or more flow-generation units or by an external influence. By evaluating the oscillations in a time range and/or frequency range (for example spectral analysis), causes of arising oscillations can be differentiated and suitable measures can be taken.

### Example 4

In general, a method or an algorithm can be performed by the network group for which a single controller does not have enough computing capacity and/or enough memory capacity to carry it out. For example, a software and/or firmware update can be transmitted to the flow-generation system via a suitable apparatus (e.g. gateway) and the update process can be carried out in a distributed manner by means of the controllers of the network group formed.

### BRIEF DESCRIPTION OF THE DRAWINGS

Advantageous configurations of the present disclosure are found in the dependent claims, the description, and the drawings. Preferred exemplary embodiments of the present disclosure are explained in detail in the following with reference to the accompanying drawings, in which:

FIG. 1 is a schematic view of an exemplary embodiment of a flow-generation system comprising a plurality of flow-generation units, which are connected to a communication network,

FIG. 2 is a block diagram of an exemplary embodiment of a flow-generation system showing the communication connection of the participants to the communication network,

FIG. 3 is a block diagram of an exemplary embodiment of a flow-generation unit of the flow-generation system according to FIGS. 1 and 2, and

FIG. 4 is a block diagram schematically showing the processing of a complex control task by flow-generation units of the flow-generation system.

### DETAILED DESCRIPTION

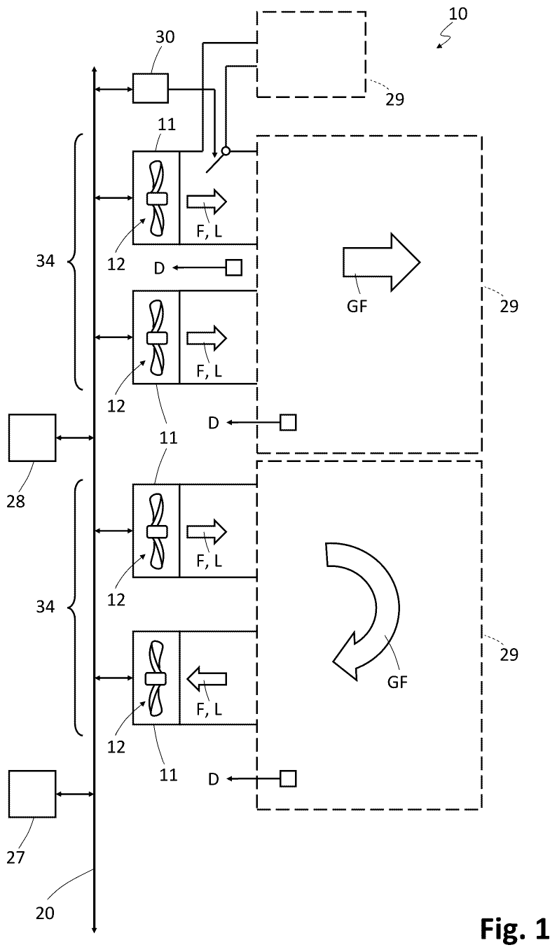

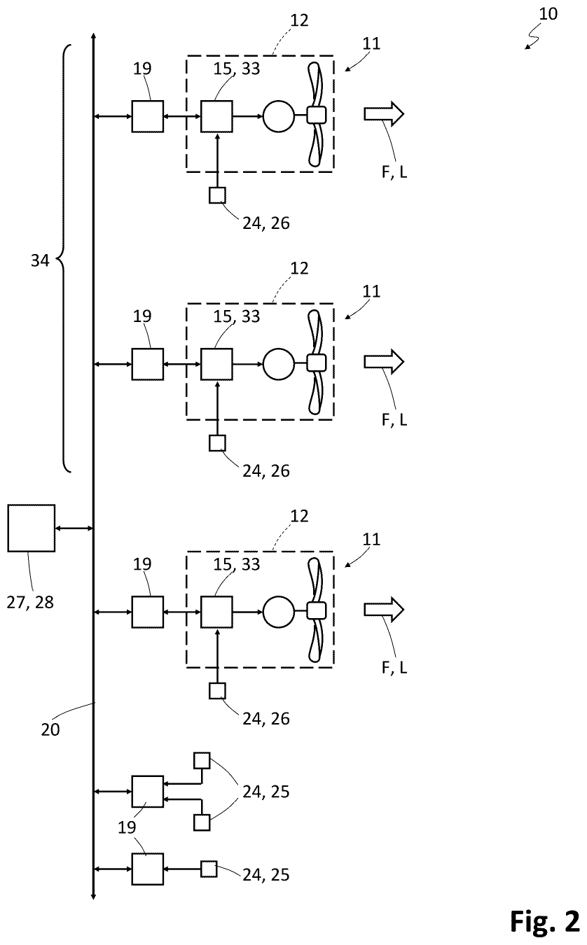

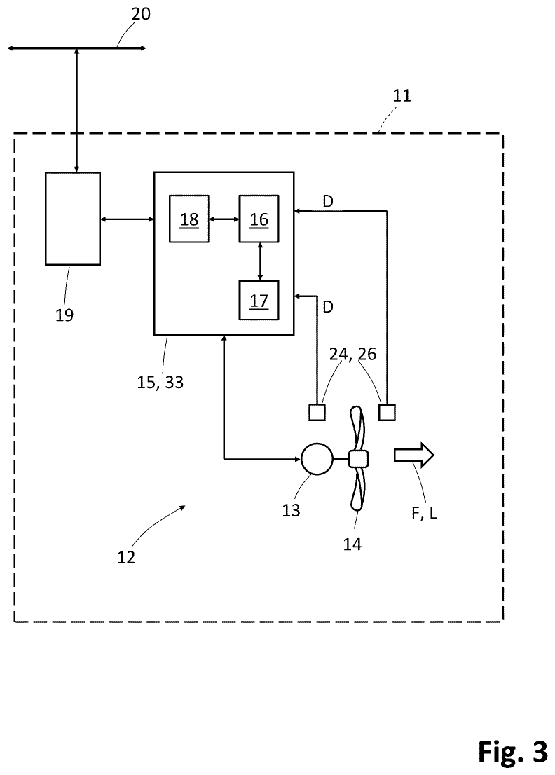

FIG. 1 shows, highly schematically and by way of example, an exemplary embodiment of a flow-generation system 10 comprising a plurality of flow-generation units 11. Each flow-generation unit 11 is configured to generate an individual fluid flow F. In the exemplary embodiment, each flow-generation unit 11 comprises a fan 12 for this purpose. Each fan 12 can generate a gas flow and, by way of example, an air flow L as the fluid flow F. The fan 12 has a fan rotor driven by an electric motor 13, which can be referred to as a fan propeller 14. The electric motor 13 is controlled by a local controller 15 of the respective flow-generation unit 11, as shown in FIGS. 2 and 3. The local controller 15 comprises at least one processor 16 and at least one working memory 17 in order to be able to perform computing processes. The local controller 15 also has a process scheduler 18, in order to be able to assign and handle the processes to be performed by the processor 16 in accordance with a predetermined strategy.

The local controller 15 of each flow-generation unit 11 is connected to a communication interface 19 for communication (FIGS. 2 and 3). Each flow-generation unit 11 is connected to a communication network 20 for communication via the communication interface. It is thus possible for the flow-generation units 11 connected to the communication network 20 to communicate with one another bidirectionally.

As also shown in FIGS. 1 to 3, the flow-generation system 10 comprises at least one sensor 24. In this case, a sensor 24 can be implemented as a system sensor 25 or as an individual sensor 26. An individual sensor 26 is allocated to one of the flow-generation units 11 and provides its sensor data D from the respective controller 15 to the flow-generation unit 11 in question. The sensor data D provided by an individual sensor 26 can optionally be transmitted indirectly via the controller 15 and the communication interface 19 to the communication network 20 and thus to other communication participants, for example other flow-generation units 11.

By contrast, a system sensor 25 is not allocated to an individual flow-generation unit 11, but instead provides its sensor data D directly to the communication network 20 via a suitable communication interface 19, such that the sensor data D are available to all the communication participants and in particular to all the flow-generation units 11. One or more or all of the flow-generation units 11 available in the flow-generation system 10 can each comprise at least one individual sensor 26. Additionally or alternatively, at least one system sensor 25 can be available. The number and type of the sensors 24 depends on the specific application.

As also shown in FIGS. 1 and 2, a gateway 27 and/or an operating interface 28 can be connected to the communication network 20 for communication. Data can be transmitted to one or more communication participants of the flow-generation system 10 and/or can be received by one of the communication participants of the flow-generation system 10 via the gateway 27 and/or the operating interface 28 automatically or manually by an operator. For example, a control task AG can be specified, selected, or modified by means of the gateway 27 and/or the operating interface 28.

FIG. 1 shows that the flow-generation units 11 can be fluidically connected to schematically shown flow spaces 29. Either only one or a plurality of flow-generation units 11 can be fluidically connected to each flow space 29. The flow spaces 29 can be spaces in a building, for example. Each flow-generation unit 11 can be connected to the flow space 29 on the suction side or pressure side and can thus either generate a fluid flow F into the flow space 29 by generating an overpressure or generate a fluid flow F out of the flow space 29 (suction flow) by generating a negative pressure. In this case, any combinations of overpressure-generated fluid flows F and/or negative-pressure-generated fluid flows F are possible for each flow space 29. Here, the view in FIG. 1 is to be understood merely by way of example. In the flow space 29, an overall fluid flow GF is generated by means of the respectively connected flow-generation units 11.

In addition to the flow-generation units 11, at least one further participant can also be connected to the communication network 20, which participant is not configured to generate a fluid flow F, but is for example configured to influence a generated fluid flow F, for example the flow direction and/or the flow rate, i.e. for example a volume flow rate and/or a mass flow rate through a flow duct. An apparatus of this kind can be a valve or generally an adjusting apparatus 30, as is shown in FIG. 1 in a highly simplified manner. By means of the adjusting apparatus 30 shown in FIG. 1, a flow duct can be closed, opened, and/or the flow cross section for a fluid flow F can be adjusted, for example.

The flow-generation system 10 can for example be part of a system installed in a building, such as a ventilation system, a heating system, a cooling system, or an air-conditioning system.

The control task AG can for example comprise at least one control parameter for an individual fluid flow F of a single flow-generation unit 11 and/or for an overall fluid flow GF jointly generated by a plurality of flow-generation units 11. A control parameter of this kind can for example be a target temperature, a target pressure, a limit value for a gas component in a flow space 29 (e.g. the radon fraction in the atmosphere), a target flow velocity, a target volume flow rate, or any combination thereof or any other suitable parameter.

In the exemplary embodiments illustrated here, the local controller 15 is implemented by a motor controller 33 of the respective electric motor 13. The local controller 15 or motor controller 33 provides only limited computing power of the processor 16 and a limited size of the working memory 17. More complex control tasks AG facing the flow-generation system 10 therefore cannot be processed by one of the local controllers 15 on its own, or can only be processed thereby to an insufficient extent.

To process control tasks AG, the local controllers 15 (here, the motor controllers 33) of a plurality of flow-generation units 11 can at least temporarily form a network group 34 (FIG. 1). For example, to accomplish a control task AG for a flow space 29, the flow-generation units 11 form a network group 34, which are in a flow connection with the respective flow space 29. Depending on the control task, however, other combinations of flow-generation units 11 can also form a network group 34 in order to provide the required computing power and/or the necessary working memory that is required for processing the specified control task AG.

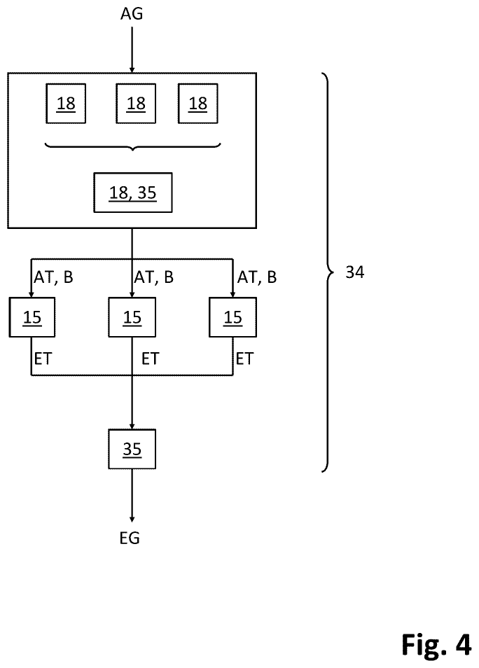

The procedure for processing a control task AG by means of a network group 34 is highly schematically shown in the block diagram according to FIG. 4.

When a control task AG is received by one of the flow-generation units 11 or the respective controller 15, the flow-generation unit 11 can request that one or more further flow-generation units 11 form a network group 34 in order to be able to process the control task AG. The flow-generation units 11 or controllers 15 involved then determine one of the process schedulers 18, which is at least temporarily used as the superordinate scheduler 35 in the network group 34 for processing the control task AG (FIG. 2). The superordinate scheduler 35 is configured to sub-divide the control task AG into a plurality of sub-tasks AT. The generated sub-tasks AT are then each allocated to a controller 15 of the flow-generation unit 11 of the network group 34. The network group 34 could also be referred to as a sub-system or a cluster.

The sub-tasks AT defined by the superordinate scheduler 35 are each processed locally by a local controller 15 in a flow-generation unit 11. At the end of the processing, each local controller 15 provides a result ET of the respective sub-task AT. The superordinate scheduler 35 merges the individual sub-results ET of the sub-tasks AT or combines them in a suitable manner in order to form the result EG of the control task AG therefrom. This result EG of the control task AG can then be used in one or more controllers 15 and/or can be output via the gateway 27 or the operating interface 28.

The approach shown in a general manner in FIG. 4 is explained in the following on the basis of specific examples.

One example can be an oscillation analysis in the frequency range. In this case, the sensor 24 or at least one of the available sensors 24 is configured as an oscillation sensor, the provided sensor data D being oscillation data. The oscillation sensor can be an acceleration sensor or a microphone. This sensor 24 can be an individual sensor 26 or a system sensor 25. It is not possible to evaluate oscillation data of this kind in the frequency range by means of a single local controller 15, or this is not possible within the required time period. Therefore, the oscillation data can be divided into data blocks B (FIG. 4), and each data block B is allocated to a sub-task AT. In this case, the sub-task AT consists in transforming the data block B of the oscillation data from the time range into the frequency range, in particular by means of a Fourier transform (e.g. a fast Fourier transform (FFT)). Optionally, in addition, the sub-task AT can involve assessing the frequency spectrum obtained by the data block B. For example, one or more frequency spectral lines can be compared with limit values and/or it can be established at which frequencies in the spectrum a maximum or a minimum occurs. These sub-spectra and/or optionally their evaluation then each represent a result ET of the sub-task AT and are merged by the superordinate scheduler 35 to form an overall spectrum that then represents the overall result EG of the control task AG. In this way, a complex control task AG, such as the spectral analysis of an oscillation, can also be carried out using very simple controllers 15 that are limited in terms of computing power and memory capacity.

If there are a plurality of oscillation sensors arranged so as to be distributed in a building or in a geographical position, the oscillation data from these sensors 24 can be related to one another. For example, an evaluation can be performed of whether oscillations or vibrations are caused by the flow-generation system 10 itself or are due to external influences. By evaluating the oscillations in a time range and/or frequency range, for example by means of a spectral analysis, as explained above, causes of arising oscillations can be differentiated and suitable measures can be taken. For example, it can be recognized whether there is a local malfunction in a flow-generation unit 11, for example an imbalance due to a damaged bearing and/or a damaged fan propeller 14 of a fan 12. In an evaluation of this kind, there is optionally also the possibility of recognizing geological tremors (earthquakes, volcanic eruptions).

As another example of a control task AG, at least one control parameter can be specified in a network group 34 for the overall fluid flow GF generated in a flow space 29. In this case, the flow-generation units 11 contributing to the overall fluid flow GF can be operated under one or more boundary conditions, for example such that the required power or energy is as low as is possible to accomplish the control or regulation objective defined by means of the at least one control parameter. Additionally or alternatively, it is possible to specify and control or regulate more than one control parameter. Each control parameter for the flow space 29 can for example be a target temperature, a target air pressure, a target flow velocity, a target air humidity, or a target value for a gas component of the atmosphere (for example the CO₂ fraction or the radon fraction). These control parameters can be combined in any way.

If one of the sensors 24 in the flow-generation system 10 generates large data volumes, in particular in a short time, i.e. has a high data rate, for example, a network group 34 can be formed in order to divide the sensor data D into data blocks B, wherein the sub-task AT can consist in compressing and/or evaluating the data block B allocated to the respective sub-task AT and in providing the compressed and/or evaluated data from the data block B (result ET of the sub-task AT). The combination of the compressed and/or evaluated data from the data blocks B then forms the result EG of the control task AG. Data compression configured in this way can be achieved rapidly by the parallel processing and the obtained compressed data can be transmitted over the communication network 20 with limited bandwidth as the result EG of the control task AG, for example can also be transmitted via the gateway 27 to another system or over the internet to a remotely arranged central processing unit.

Another example of a control task AG that can be processed by means of a network group 34 is that of ascertaining the remaining service life of at least one flow-generation unit 11. The respective controller 15 can distribute the calculations required for this purpose to a plurality of controllers 15 of the network group 34 and can combine the thus provided results ET of the sub-tasks AT again in order to estimate the remaining service life. The remaining service life can then be used in the controller 15, for example to influence control parameters. In this context, it is e.g. possible to limit the power of a flow-generation unit 11 in order to extend the remaining service life or to not shorten it further.

In general, methods, algorithms, software updates and/or firmware updates, or the like can be performed by a network group 34 for which a single controller 15 does not have enough computing capacity and/or enough memory capacity to carry it out. For example, software updates and/or firmware updates can be transmitted via the gateway 27 and/or a dongle or another apparatus and the update process can be carried out in a distributed manner in the controllers 15 of a network group 34 that is formed.

The present disclosure relates to a flow-generation system 10 and to a method for its operation. The flow-generation system 10 has a plurality of flow-generation units 11, which are each configured to generate an individual fluid flow F, in particular an air flow L. For this purpose, the flow-generation unit 11 can comprise an electromotively operated fan 12, for example. A local controller 15 has a processor 16, a working memory 17, and a process scheduler 18, and is connected to a communication network 20 for communication via a communication interface 19. A control task AG can be processed in parallel by a network group 34 by means of a plurality of local controllers 15 of the flow-generation units 11 belonging to the network group 34 when one single local controller 15 does not have enough computing power and/or memory capacity for processing the control task AG. In this case, complex control tasks AG can also be processed without an internet-based service cloud service connected to the flow-generation system 10 or a server or increased computing and memory capacity of the local controllers 15 necessarily being required for this purpose.

### LIST OF REFERENCE SIGNS

10 Flow-generation system
11 Flow-generation unit
12 Fan
13 Electric motor
14 Fan propeller
15 Local controller
16 Processor
17 Working memory
18 Process scheduler
19 Communication interface
20 Communication network
24 Sensor
25 System sensor
26 Individual sensor
27 Gateway
28 Operating interface
29 Flow space
30 Adjusting apparatus
33 Motor controller
34 Network group
35 Superordinate scheduler
AG Control task
AT Sub-task
B Data block
D Sensor data from a sensor
EG Result of the control task
ET Result of the sub-task
F Fluid flow
GF Overall fluid flow
L Air flow

1. A flow-generation system comprising a plurality of flow-generation units, which are connected for communication by means of a communication network,
wherein each flow-generation unit of the plurality of flow-generation units comprises a local controller having a processor and having a process scheduler and a communication interface connected to the local controller for communication and for connection to the communication network,
wherein each flow-generation unit of the plurality of flow-generation units is configured to form a network group together with one or more or all of the other flow-generation units of the plurality of flow-generation units, the network group is configured to process a control task in a distributed manner by the processor of each flow-generation unit of the plurality of flow-generation units of the network group, wherein the process scheduler of one of the plurality of flow-generation units operates as a superordinate scheduler and is configured to define sub-tasks of the control task, to assign the sub-tasks to the processor of each flow-generation unit of the plurality of flow-generation units of the network group, and to combine results of the sub-tasks for processing the control task,
wherein the flow-generation system also comprises at least one sensor which provides sensor data for one or more flow-generation units of the plurality of flow-generation units, and
wherein the superordinate scheduler is configured to divide the sensor data from the at least one sensor or from at least one of available sensors into data blocks and to allocate each data block of the data blocks to a sub-task.

2. The flow-generation system according to claim 1, wherein each flow-generation unit of the plurality of flow-generation units is configured to control or regulate the generation of an individual fluid flow by means of the local controller independently of other flow-generation units of the plurality of flow-generation units.

3. The flow-generation system according to claim 1, wherein a cloud service for processing the control task is not available to the communication network.

4. The flow-generation system according to claim 1, wherein the at least one sensor or at least one of available sensors is an individual sensor of one of the plurality of flow-generation units.

5. The flow-generation system according to claim 4, wherein the at least one sensor or at least one of available sensors is a system sensor, which is connected to the communication network for communication independently of the plurality of flow-generation units.

6. The flow-generation system according to claim 1, wherein each sub-task involves compressing and/or evaluating the allocated data block.

7. The flow-generation system according to claim 1, wherein the control task involves evaluating the sensor data in a frequency range.

8. The flow-generation system according to claim 1, wherein at least one sensor is a plurality of sensors and the control task involves assessing sensor data from the plurality of sensors in order to obtain information that goes beyond information content of the sensor data from a single sensor of the plurality of sensors.

9. The flow-generation system according to claim 1, wherein each local controller of the plurality of flow-generation units is configured to request the formation of a network group.

10. The flow-generation system according to claim 1, wherein the control task specifies a target parameter, and wherein each of the plurality of flow-generation units of the network group are configured to coordinate their respective local controller in order to jointly generate an overall fluid flow with the aim of fulfilling the target parameter.

11. The flow-generation system according to claim 1, wherein each flow-generation unit of the plurality of flow-generation units of the network group is allocated to a joint flow space.

12. The flow-generation system according to claim 1, wherein the local controller of each of the plurality of flow-generation units is a motor controller of an electric motor of a respective one of the plurality of flow-generation units.

13. The flow-generation system according to claim 1, also comprising an operating interface and/or a gateway, which is connected to the communication network for communication and is configured to specify and/or select and/or change the control task.

14. A method for operating a flow-generation system comprising a plurality of flow-generation units, which are connected for communication by means of a communication network, and also comprising at least one sensor which provides sensor data for one or more flow-generation units of the plurality of flow-generation units, wherein each flow-generation unit of the plurality of flow-generation units comprises a local controller having a processor and having a process scheduler and a communication interface connected to the local controller for communication for connection to the communication network, wherein the method comprises:
specifying a control task,
temporarily forming a network group from a plurality of or all of the plurality of flow-generation units for distributed processing of the control task by means of the processor of the plurality of or all of the plurality of flow-generation units of the network group,
determining a superordinate scheduler of the process scheduler of each of the plurality of flow-generation units of the network group,
defining sub-tasks for processing the control task by means of the superordinate scheduler,
dividing the sensor data from the at least one sensor or from at least one of available sensors into data blocks and allocating each data block of the data blocks to a sub-task by means of the superordinate scheduler,
allocating each sub-task of the sub-tasks to one processor of the plurality of flow-generation units of the network group,
processing each sub-task of the sub-tasks and providing a result of each sub-task of the sub-tasks for the superordinate scheduler by means of the one processor of the plurality of flow-generation units,
combining the result of each sub-task of the sub-tasks by means of the superordinate scheduler.

15. The flow-generation system according to claim 2, wherein a cloud service for processing the control task is not available to the communication network.

16. The flow-generation system according to claim 15, also comprising at least one sensor which provides sensor data for one or more flow-generation units of the plurality of flow-generation units.

17. The flow-generation system according to claim 16, wherein the at least one sensor or at least one of available sensors is an individual sensor of one of the plurality of flow-generation units.

18. The flow-generation system according to claim 16, wherein the at least one sensor or at least one of available sensors is a system sensor, which is connected to the communication network for communication independently of the plurality of flow-generation units.
